(19) United States
(12) Patent Application Publication
(10) Pub. No.: US 2007/0032383 A1
(43) Pub. Date: Feb. 8, 2007

(54) Systems, methods, and compositions for modifying the metabolism of plants and of euucaryotic microbes

(76) Inventor: M. Karen Newell, Colorado Springs, CO (US)

Correspondence Address: BERLINER & ASSOCIATES, 555 WEST FIFTH STREET, 31ST STREET, LOS ANGELES, CA, 90013, US

(21) Appl. No.: 11/493,985

(22) Filed: Jul. 27, 2006

Related U.S. Application Data
(60) Provisional application No. 60/703,232, filed on Jul. 27, 2005.

(51) Int. Cl. A01N 43/02; A01N 43/20

(52) U.S. Cl. 504/291; 514/475

(57) ABSTRACT

Systems, methods, and compositions for modifying the metabolsim of plants and of eucaryotic microbes, and for culturing them for the production of lipids with high concentrations of omega-3 highly unsaturated fatty acids (HUFA) suitable for human and animal consumption as food additives or for use in pharmaceutical and industrial products. The metabolic modifier is added to a fermentation or growth medium, and is selected from the group consisting essentially of a fatty acid metabolism inhibitor, glycolysis inhibitor, a bifunctional compound that links a fatty acid metabolism inhibitor to a glycolysis inhibitor, glucose, insulin, and a plant growth factor.

### CROSS-REFERENCE TO RELATED APPLICATIONS

This application claims the benefit of Provisional Patent Application No. 60/703,232, filed Jul. 27, 2005.

### FIELD OF INVENTION

The field of the invention generally relates to systems, methods, and compositions for modifying the metabolsim of plants and of Eucaryotic microbes, and for culturing them for the production of lipids with high concentrations of omega-3 highly unsaturated fatty acids (HUFA) suitable for human and animal consumption as food additives or for use in pharmaceutical and industrial products.

### BACKGROUND

Omega-3 highly unsaturated fatty acids (HUFAs) are of significant commercial interest as important dietary compounds for preventing arteriosclerosis and coronary heart disease, for alleviating inflammatory conditions and for retarding the growth of tumor cells. These beneficial effects are a result both of omega-3 HUFAs causing competitive inhibition of compounds produced from omega-6 fatty acids, and from beneficial compounds produced directly from the omega-3 HUFAs themselves. Omega-6 fatty acids are the predominant HUFAs found in plants and animals. Commercially available sources of omega-3 HUFAS are the microflora Thraustochytrium and Schizochytrium which are discussed in detail in U.S. Pat. No. 5,130,242 by William M. Barclay, the entire disclosure of which is incorporated herein by reference. These microflora have the advantages of being heterotrophic and capable of high levels of omega-3 HUFA production.

Eukaryotic microbes (such as algae; fungi, including yeast; and protists) have been demonstrated to be good producers of polyenoic fatty acids in fermentors; see U.S. Patent Application Publication Number 2003/0180898 by Richard B. Bailey et al., published Sep. 25, 2003 and entilted: “Enhanced production of lipids containing polyenoic fatty acid by very high density cultures of eukaryotic microbes in fermentors”, incorporated herein in its entirety.

There still exists a need for improved methods for fermentation of these microflora and of production of plant originating fatty acids.\

### SUMMARY OF INVENTION

The invention generally relates to systems, methods, and compositions for modifying the metabolsim of plants and of eucaryotic microbes, and for culturing them for the production of lipids with high concentrations of omega-3 highly unsaturated fatty acids (HUFA) suitable for human and animal consumption as food additives or for use in pharmaceutical and industrial products. The metabolic modifier is added to a fermentation or growth medium, and is selected from the group consisting essentially of a fatty acid metabolism inhibitor, glycolysis inhibitor, a bifunctional compound that links a fatty acid metabolism inhibitor to a glycolysis inhibitor, glucose, insulin, and a plant growth factor.

In a preferred embodiment, the bifunctional compound links a fatty acid inhibitor to an inhibitor that is, or is derived from, or has the functionality of, hypoglycin A (also referred to as hypoglycine A), which can serve as both a glycolysis inhibitor and a fatty acid metabolism inhibitor. In other preferred embodiments, the fatty acid metabolism inhibitor has the functionality of an oxirane carboxylic acid compound. In another preferred embodiment, the glycolysis inhibitor has the functionality of 2-deoxy-D-glucose. In specific embodiments, the invention provides a bifunctional compound that links a moiety having the functionality of etomoxir to a moiety having the functionality of hypoglycin A. In other specific embodiments, the invention provides a bifunctional compound that links a moiety having the functionality of etomoxir to a moiety having the functionality of 2-deoxy-D-glucose.

In yet another aspect of the present invention, the eucaryotic microbes are selected from the group consisting of algae, fungi, protists, and mixtures thereof, wherein the microorganisms are capable of producing polyenoic fatty acids or other lipids which requires molecular oxygen for their synthesis. A particularly useful microorganisms of the present invention are eukaryotic microorganisms which are capable of producing lipids at a fermentation medium oxygen level of about less than 3% of saturation.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF DRAWINGS

FIGS. 1A-1C illustrate certain compounds for use with the invention;

FIG. 2 shows generic chemical structures of five embodiments of the bifunctional compounds of this invention;

FIG. 3 shows the chemical structures of five specific bifunctional compounds of this invention;

FIG. 4 shows generic chemical structures (I), (II), and (III) of a first set of three embodiments of bifunctional compounds of this invention;

FIG. 5 shows generic chemical structures (IV), (V), and (VI) of a second set of three embodiments of bifunctional compounds of this invention;

FIG. 6 shows generic chemical structures (VII), (VIII), and (IX) of a third set of three embodiments of bifunctional compounds of this invention;

FIG. 7 shows generic chemical structures (X), (XI), and (XII) of a fourth set of three embodiments of bifunctional compounds of this invention;

FIG. 8 shows specific chemical structures (XIII), (XIV), and (XV) of a set of bifunctional compounds of this invention within the generic structures, respectively (I), (II), and (III), of FIG. 1;

FIG. 9 shows specific chemical structures (XVI), (XVII), and (XVIII) of a set of bifunctional compounds of this invention within the generic structures, respectively (IV), (V), and (VI), of FIG. 2;

FIG. 10 shows specific chemical structures (XIX), (XX), and (XXI) of a set of bifunctional compounds of this invention within the generic structures, respectively (VII), (VIII), and (IX), of FIG. 3;

FIG. 11 shows specific chemical structures (XXII), (XXIII), and (XIV) of a set of bifunctional compounds of this invention within the generic structures, respectively (X), (X), and (XI), of FIG. 4; and

FIG. 12 shows specific chemical structures (XXV), (XXVI), and (XXVII) of a set of bifunctional compounds of this invention within the generic structures, respectively (XI), (XII), and (XII), of FIG. 4

### DETAILED DESCRIPTION

The present invention proceeds by recognizing that cells of all types, plant as well as eucaryotic microbes, have available to them a number of different metabolic strategies, and that by modifying particular strategies, one can cause the plant or microbe to generate increased yields of desired product, exemplified by omega-6 HUFAs in plants and omega-3 HUFAs in eucaryotic microbes. Inhibiting fatty acid metabolism enables the cell to accumulate faty acids. Since glucose is used as a building block of fatty acid synthesis, by inhibiting glycolysis, more glucose is available for the production of fatty acids. Using a bifunctional compound that links a fatty acid metabolism inhibitor to a glycolysis inhibitor enables both fatty acid accumulation and fatty acid synthesis. Glucose, insulin, or a plant growth factor, each have salutory effects.

As used herein, the term “plant” is used in its broadest sense. The term plant includes, but is not limited to, any species of woody, ornamental or decorative, crop or cereal, fruit or vegetable plant, and algae (e.g., Chlamydomonas reinhardtii). As used herein, the term “cereal crop” is used in its broadest sense. The term includes, but is not limited to, any species of grass, or grain plant (e.g., barley, corn, oats, rice, wild rice, rye, wheat, millet, sorghum, triticale, etc.), non-grass plants (e.g., buckwheat flax, legumes [soybeans] etc.), or other common plant derived carbohydrate source, etc. As used herein, the term “crop” or “crop plant” is used in its broadest sense. The term includes, but is not limited to, any species of plant or algae edible by humans or used as a feed for animals or used, or consumed by humans, or any plant or algae used in industry or commerce.

As used herein, the term “eucaryotic microbe,” which some refer to as “eukaryotic microbe,” includes fungi (including yeast), algae, and protists. More particularly, preferred embodiments include growing marine microorganisms, in particular algae, such as Thraustochytrids of the order Thraustochytriales, more specifically Thraustochytriales of the genus Thraustochytrium and Schizochytrium, including Thraustochytriales which are disclosed in commonly assigned U.S. Pat. Nos. 5,340,594 and 5,340,742, both issued to Barclay, all of which are incorporated herein by reference in their entirety. Fungi are any of numerous eukaryotic organisms of the kingdom Fungi, which lack chlorophyll and vascular tissue and range in form from a single cell to a body mass of branched filamentous hyphae that often produce specialized fruiting bodies. The kingdom includes the yeasts, molds, smuts, and mushrooms. Algae are ny of various chiefly aquatic, eukaryotic, photosynthetic organisms, ranging in size from single-celled forms to the giant kelp. Algae were once considered to be plants but are now classified separately because they lack true roots, stems, leaves, and embryos. Protists are any of the eukaryotic, unicellular organisms of the former kingdom Protista, which includes protozoans, slime molds, and certain algae. The protists now belong to the kingdom Protoctista, a new classification in most modem taxonomic systems.

The metabolic modifier is selected from the group consisting essentially of a fatty acid metabolism inhibitor, glycolysis inhibitor, a bifunctional compound that links a fatty acid metabolism inhibitor to a glycolysis inhibitor, glucose, insulin, and a plant growth factor. Additional inhibitors may include inhibitors of gluconeogenesis and CO2 fixation in plants that indirectly promote storage of fat. Glucose and insulin need no further explanation as to their nature or type.

Plant Growth Factor

The term “plant growth factor” is usually employed for plant hormones or substances of similar effect that are administered to plants. Classes of plant hormones (phytohormones) are auxins, cytokinins, gibberellins, abscisic acid, ethylene, and more recently, polyamines such as putrescine or spermidine. They are physiological intercellular messengers that are needed to control the complete plant lifecycle, including germination, rooting, growth, flowering, fruit ripening, foliage and death. In addition, plant hormones are secreted in response to environmental factors such as abundance of nutrients, drought conditions, light, temperature, chemical or physical stress. Hence, levels of hormones will change over the lifespan of a plant and are dependent upon season and environment. Plant growth factors are widely used in industrialized agriculture to improve productivity. The application of growth factors allows synchronization of plant development to occur.

Fatty Acid Metabolism Inhibitors

A “fatty acid metabolism inhibitor,” as used herein, is a compound able to inhibit (e.g., prevent, or at least decrease or inhibit the activity by an order of magnitude or more) a reaction within the fatty acid metabolism pathway, such as an enzyme-catalyzed reaction within the pathway. The inhibitor may inhibit the enzyme, e.g., by binding to the enzyme or otherwise interfering with operation of the enzyme (for example, by blocking an active site or a docking site, altering the configuration of the enzyme, competing with an enzyme substrate for the active site of an enzyme, etc.), and/or by reacting with a coenzyme, cofactor, etc. necessary for the enzyme to react with a substrate. The fatty acid metabolism pathway is the pathway by which fatty acids are metabolized within a cell for energy (e.g., through the synthesis of ATP and the breakdown of fatty acids into simpler structures, such as CO_{2,} acyl groups, etc.).

The fatty acid metabolism pathway includes several enzymatic reactions, which uses various enzymes such as reductases or isomerases. Specific examples of enzymes within the fatty acid metabolism pathway include 2,4-dienoyl-CoA reductase, 2,4-dienoyl-CoA isomerase, butyryl dehydrogenase, etc, as further discussed below. In one embodiment, the fatty acid metabolism inhibitor is an inhibitor able to inhibit a beta-oxidation reaction in the fatty acid metabolism pathway. In another embodiment, the inhibitor is an inhibitor for a fatty acid transporter (e.g., a transporter that transports fatty acids into the cell, or from the cytoplasm into the mitochondria for metabolism). In yet another embodiment, the inhibitor may react or otherwise inhibit key steps within the fatty acid metabolism pathway. In still another embodiment, the inhibitor may be an inhibitor of fatty acids as a source of energy in the mitochondria. For example, the inhibitor may inhibit the breakdown of intermediates such as butyryl CoA, glutaryl CoA, or isovaleryl CoA.

2,4-dienoyl-CoA reductase is an enzyme within the fatty acid metabolism pathway that catalyzes reduction reactions involved in the metabolism of polyunsaturated fatty acids. Certain fatty acids are substrates for 2,4-dienoyl-CoA reductases located within the mitochondria. In some cases, fatty acids may be transported into the mitochondria through uncoupling proteins. The uncoupling protein may, in certain instances, increase the mitochondrial metabolism to increase the availability of fatty acids within the mitochondria and/or increase the throughput of beta-oxidation within the mitochondria.

The enzyme 2,4-dienoyl-CoA isomerase is an enzyme within the fatty acid metabolism pathway that catalyzes isomerization of certain fatty acids. One step in the metabolism of certain polyunsaturated fatty acids may be protective against reactive oxygen intermediates (“ROI”). Thus, by generating substrates and antagonists for the activity of 2,4-dienyol-CoA isomerase, the metabolic production of reactive oxygen intermediates may be enhanced and/or reduced. This, in turn, may affect certain disease states, such as cancer.

Thus, it is to be understood that, as used herein, compounds useful for inhibiting fatty acid metabolism (i.e., “fatty acid metabolism inhibitors”) are also useful for altering cellular production of reactive oxygen; compounds described in reference to fatty acid metabolism inhibition should also be understood herein to be able to alter reactive oxygen production within a cell. For example, by altering the ability of a cell to metabolize a fatty acid, the ability of the cell to produce reactive oxygen may also be affected, since one pathway for a cell to produce reactive oxygen intermediates is through the metabolism of fatty acids. Alteration of the production of reactive oxygen in a cell may be associated with changes in the immune profile of cells, i.e., how immune cells respond to the cell. Thus, in some cases, the production of reactive oxygen can be affected by exposing a cell to, or removing a cell from, a fatty acid metabolism inhibitor.

In a preferred embodiment of the invention, the fatty acid inhibitor is an oxirane carboxylic acid compound. In accordance with a discovery of this invention, such compounds, exemplified by etomoxir, are able to alter cellular production of reactive oxygen. Preferred oxirane carboxylic acid compounds have the formula: 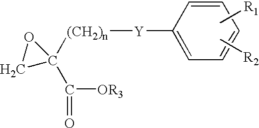
wherein: R₁ represents a hydrogen atom, a halogen atom, a 1-4C alkyl group, a 1-4C alkoxy group, a nitro group or a trifluoromethyl group; R₂ has one of the meanings of R_{1;} R₃ represents a hydrogen atom or a 1-4C alkyl group; Y represents the grouping —O—(CH₂)ₘ—; m is 0 or a whole number from 1 to 4; and n is a whole number from 2 to 8 wherein the sum of m and n is a whole number from 2 to 8. More preferred are oxirane carboxylic acid compounds wherein R₁ is a halogen atom, R₂ is a hydrogen atom, m is 0, and n is 6, and more particulary where R₃ is an ethyl group.

It is most particularly preferred to use etomoxir, i.e., 2-(6-(4-chlorophenoxy)-hexyl)-oxirane-2-carboxylic acid ethyl ester. Examples of other oxirane carboxylic acid compounds useful in the invention are 2-(4-(3-chlorophenoxy)-butyl)-oxirane-2-carboxylic acid ethyl ester, 2-(4-(3-trifluoromethylphenoxy)-butyl)-oxirane-2-carboxylic acid ethyl ester, 2-(5-(4-chlorophenoxy)-pentyl)-oxirane-2-carboxylic acid ethyl ester, 2-(6-(3,4-dichlorophenoxy)-hexyl)-oxirane-2-carboxylic acid ethyl ester, 2-(6-(4-fluorophenoxy)-hexyl)-oxirane-2-carboxylic acid ethyl ester, and 2-(6-phenoxyhexyl)-oxirane-2-carboxylic acid ethyl ester, the corresponding oxirane carboxylic acids, and their pharmacologically acceptable salts.

The foregoing class of oxirane carboxylic acid compounds, including etomoxir, has been described by Horst Wolf and Klaus Eistetter in U.S. Pat. No. 4,946,866 for the prevention and treatment of illnesses associated with increased cholesterol and/or triglyceride concentration, and by Horst Wolf in U.S. Pat. No. 5,739,159 for treating heart insufficiency. The preparation of oxirane carboxylic acid compounds, and their use for blood glucose lowering effects as an antidiabetic agent, is described in Jew et al U.S. Pat. No. 6,013,666. Etomoxir has been described as an inhibitor of mitochondrial carnitine palmitoyl transferase-I .by Mannaerts, G. P., L. J. Debeer, J. Thomas, and P. J. De Schepper. “Mitochondrial and peroxisomal fatty acid oxidation in liver homogenates and isolated hepatocytes from control and clofibrate-treated rats,” J. Biol. Chem. 254:4585-4595, 1979. United States Patent Application 20030036199 by Bamdad et al, entitled:” Diagnostic tumor markers, drug screening for tumorigenesis inhibition, and compositions and methods for treatment of cancer,” published Feb. 20, 2003, describes treating a subject having a cancer characterized by the aberrant expression of MUC1, comprising administering to the subject etomoxir in an amount effective to reduce tumor growth.

The foregoing U.S. Pat. Nos. 4,946,866, 5,739,159, and 6,013,666, United States Patent Application 20030036199, and the foregoing publication by Mannaerts, G. P., L. J. Debeer, J. Thomas, and P. J. De Schepper, are incorporated herein by reference. In addition, U.S. patent application Ser. No. 10/272,432, filed Oct. 15, 2002, entitled “Methods for Regulating Co-Stimulatory Molecule Expression with Reactive Oxygen,” by M. K. Newell, et al. is incorporated herein by reference in its entirety

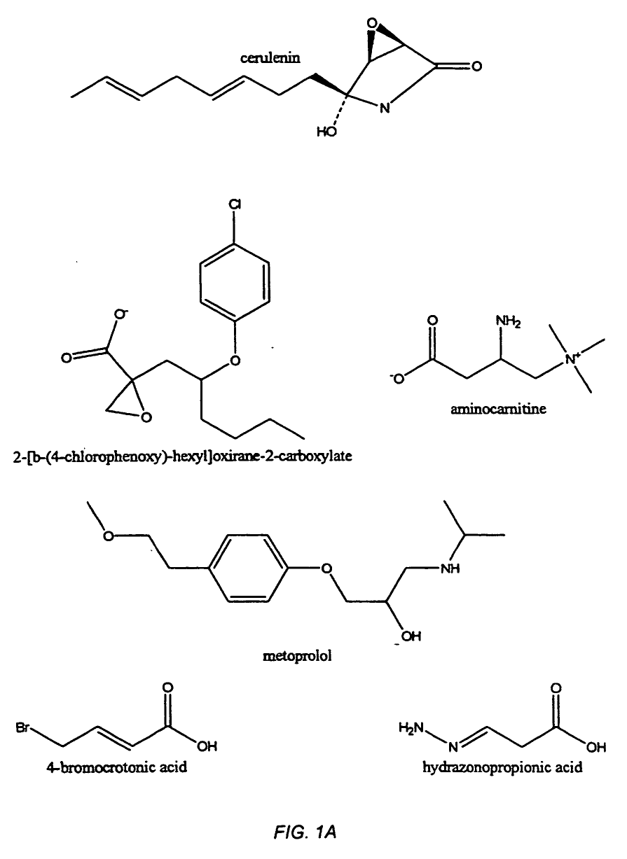

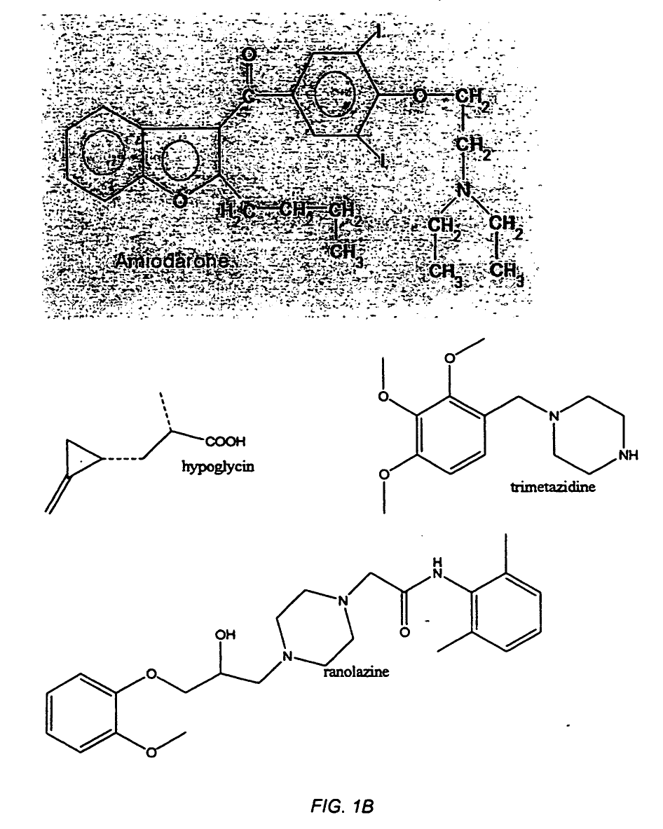

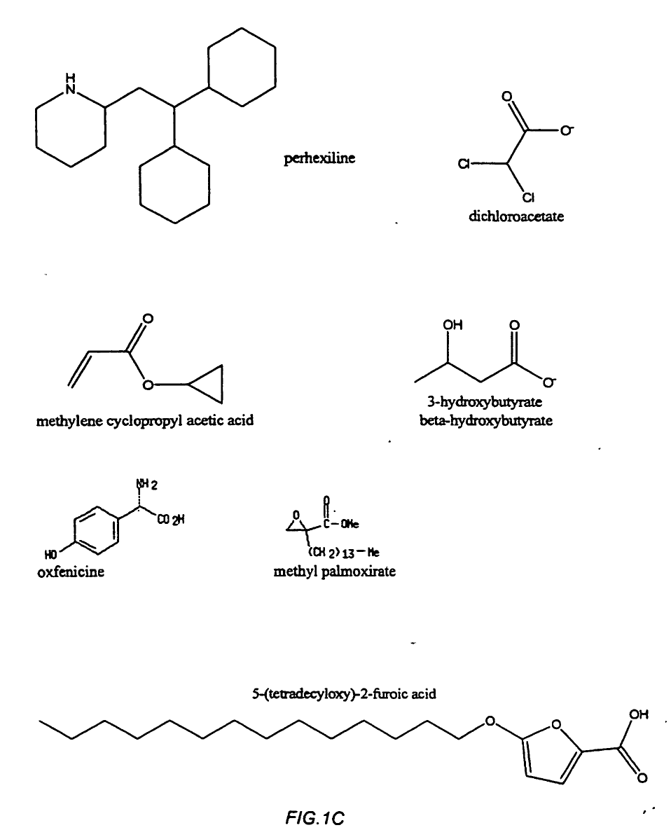

Other, non-limiting examples of fatty acid metabolism inhibitors include fatty acid transporter inhibitors, beta-oxidation process inhibitors, reductase inhibitors, and/or isomerase inhibitors within the fatty acid metabolism pathway. Specific examples of other fatty acid metabolism inhibitors include, but are not limited to, cerulenin, 5-(tetradecyloxy)-2-furoic acid, oxfenicine, methyl palmoxirate, metoprolol, amiodarone, perhexiline, aminocarnitine, hydrazonopropionic acid, 4-bromocrotonic acid, trimetazidine, ranolazine, hypoglycin, dichloroacetate, methylene cyclopropyl acetic acid, and beta-hydroxy butyrate. Structural formulas for these inhibitors are shown in FIG. 1A-1C. As a another example, the inhibitor may be a non-hydrolyzable analog of carnitine.

In one embodiment, the fatty acid metabolism inhibitor is a carboxylic acid. In some cases, the carboxylic acid may have the structure: 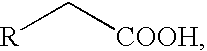
where R comprises an organic moiety, as further described below. In some cases, R may include at least two nitrogen atoms, or R may include an aromatic moiety (as further described below), such as a benzene ring, a furan, etc.

In another embodiment, the fatty acid metabolism inhibitor has the structure: 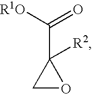
where each of R¹ and R² independently comprises organic moiety. In some instances, either or both of R¹ and R² may independently be an alkyl, such as a straight-chain alkyl, for instance, methyl, ethyl, propyl, etc. In certain cases, R2 may have at least 5 carbon atoms, at least 10 carbon atoms, or at least 15 or more carbon atoms. For example, in one embodiment, R² may be a tetradecyl moiety. In other cases, R² may include an aromatic moiety, for example, a benzene ring. In still other cases, R² may have the structure: 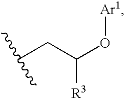
where R³ comprises an organic moiety and Ar¹ comprises an aromatic moiety. R³ may be a an alkyl, such as a straight-chain alkyl. In some instances, Ar¹ may be a benzene ring or a derivative thereof, i.e., having the structure: 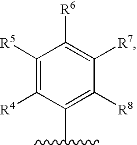
wherein each of R⁴, R⁵, R⁶, R⁷, and R⁸ is hydrogen, a halogen, an alkyl, an alkoxy, etc.

In yet another embodiment, the fatty acid metabolism inhibitor has the structure: 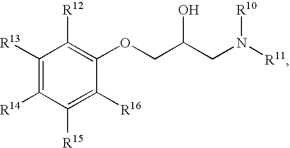
where each of R¹⁰, R¹¹, R¹², R¹³, R¹⁴, R¹⁵ and R¹⁶ independently comprises hydrogen, a halogen, or an organic moiety, such as an alkyl, an alkoxy, etc. In some cases, R¹⁰ and R¹¹ together may define an organic moiety, such as a cyclic group. For example, the fatty acid metabolism inhibitor may have the structure: 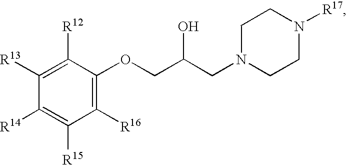
wherein R¹⁷ comprises an organic moiety, such as an alkyl, an alkoxy, an aromatic moiety, an amide, etc. An example, of R¹⁷ is: 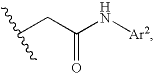
wherein Ar² comprises an aromatic moiety, such as a benzene ring or a benzene derivative, as previously described.

In still another embodiment, the fatty acid metabolism inhibitor includes a dominant negative plasma membrane polypeptide. The end result of the use (e.g., expression) of a dominant negative polypeptide in a cell may be a reduction in functional enzymes present within the fatty acid metabolism pathway. One of ordinary skill in the art can assess the potential for a dominant negative variant of a protein or enzyme, and use standard mutagenesis techniques to create one or more dominant negative variant polypeptides. For example, one of ordinary skill in the art can modify the sequence of an enzyme coding region by site-specific mutagenesis, scanning mutagenesis, partial gene deletion or truncation, and the like. See, e.g., U.S. Pat. No. 5,580,723 and Sambrook, et al., Molecular Cloning: A Laboratory Manual, Second Edition, Cold Spring Harbor Laboratory Press, 1989. One of ordinary skill in the art then can test the population of mutagenized polypeptides for diminution in a selected and/or for retention of such activity of the protein or enzyme. Other similar methods for creating and testing dominant negative variants of a protein will be apparent to one of ordinary skill in the art.

In another set of embodiments, the cells may be exposed to an agent that inhibits the synthesis or production of one or enzymes within the fatty acid metabolism pathway. Exposure of the cells to the agent thus inhibits fatty acid metabolism within the cell. For example, in one embodiment, an antisense oligonucleotide may be used that selectively binds to regions encoding enzymes present within the fatty acid metabolism pathway, such as 2,4-dienoyl-CoA reductase or 2,4-dienoyl-CoA isomerase. Antisense oligonucleotides are discussed in more detail below.

Glucose Metabolism Inhibitor

Preferred glucose metabolism inhibitors are 2-deoxyglucose compounds, defined herein as 2-deoxy-D-glucos, and homologs, analogs, and/or derivatives of 2-deoxy-D-glucose. While the levo form is not prevalent, and 2-deoxy-D-glucose is preferred, the term “2-deoxyglucose” is intended to cover inter alia either 2-deoxy-D-glucose and 2-deoxy-L-glucose, or a mixture thereof. In general glucose metabolism inhibitors can have the formula: 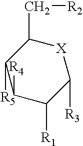
wherein: X represents an O or S atom; R₁ represents a hydrogen atom or a halogen atom; R₂ represents a hydroxyl group, a halogen atom, a thiol group, or CO—R₆; and R₃, R₄, and R₅ each represent a hydroxyl group, a halogen atom, or CO—R₆ wherein R₆ represents an alkyl group of from 1 to 20 carbon atoms, and wherein at least two of R₃, R₄, and R₅ are hydroxyl groups. The halogen atom is as described above with respect to the oxirane carboxylic acid compounds, and in R₂, R₃, R₄, and R_{5.} The halogen atom is preferably F, and R₆ is preferably a C₃-C₁₅ alkyl group.

Examples of 2-deoxyglucose compounds useful in the invention are: 2-deoxy-D-glucose, 2-deoxy-L-glucose; 2-bromo-D-glucose, 2-fluoro-D-glucose, 2-iodo-D-glucose, 6-fluoro-D-glucose, 6-thio-D-glucose, 7-glucosyl fluoride, 3-fluoro-D-glucose, 4-fluoro-D-glucose, 1-O-propyl ester of 2-deoxy-D-glucose, 1 -O-tridecyl ester of 2-deoxy-D-glucose, 1-O-pentadecyl ester of 2-deoxy-D-glucose, 3 -O-propyl ester of 2-deoxy-D-glucose, 3-O-tridecyl ester of 2-deoxy-D-glucose, 3-O-pentadecyl ester of 2-deoxy-D-glucose, 4-O-propyl ester of 2-deoxy-D-glucose, 4-O-tridecyl ester of 2-deoxy-D-glucose, 4-O -pentadecyl ester of 2-deoxy-D-glucose, 6-O-propyl ester of 2-deoxy-D-glucose, 6-0-tridecyl ester of 2-deoxy-D-glucose, 6-O-pentadecyl ester of 2-deoxy-D-glucose, and 5-thio-D-glucose, and mixtures thereof.

A preferred glucose metabolism inhibitor is 2-deoxy-D-glucose, which has the structure: 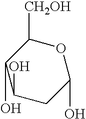
Bifunctional Compounds

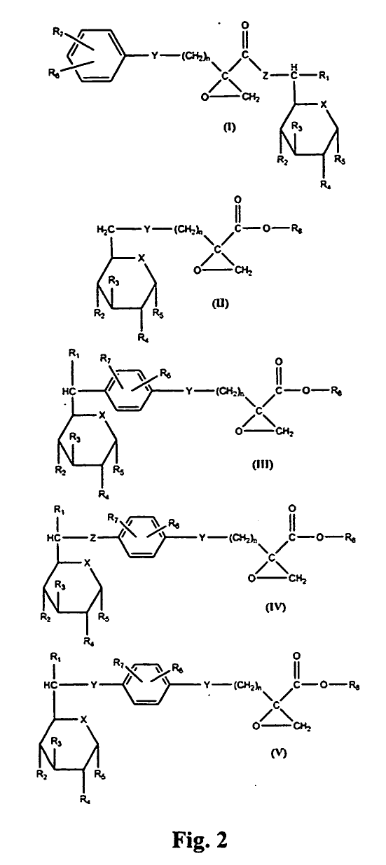

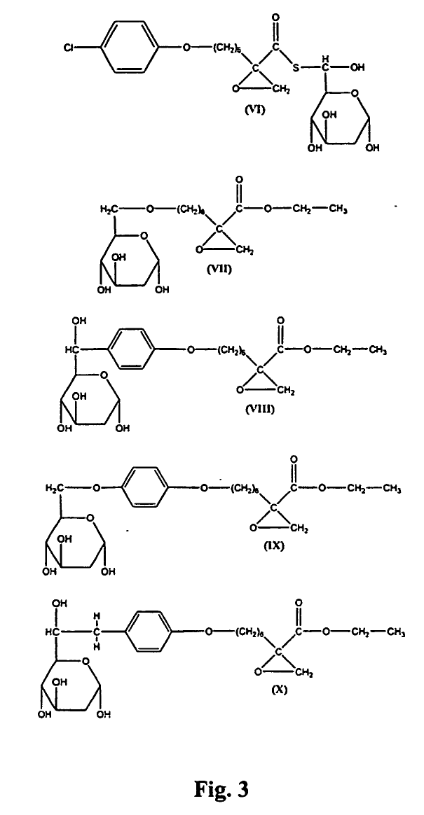

The bifunctional compounds in their most generic form link a moiety functioning as a fatty acid metabolism inhibitor to a moiety functioning as a glycolysis inhibitor. Referring to FIG. 2, generic forms of five bifunctional compounds, respectively compounds (I) to (V), are shown, and respective specific preferred bifunctional compounds are shown in FIG. 3 as respective compounds (VI) to (X), each of which will be referred to in more detail in the following examples, each of which link a moiety having the functionality of an oxirane carboxylic acid to a moiety having the functionality of a 2-deoxyglucose compound.

### EXAMPLE 1

One can use in the invention, the bifunctional compound (I) of FIG. 2, having the structure: 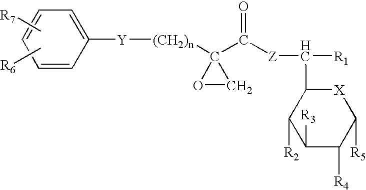
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, Y represents (CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4.

A preferred specific bifunctional compound (I) is shown in FIG. 3 as compound (VI), having the structure:

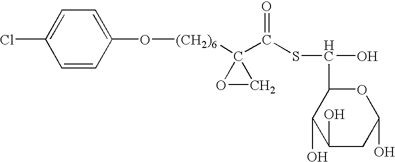

### EXAMPLE 2

One can use in the invention, the bifunctional compound (II) of FIG. 2, having the structure: 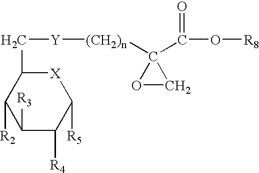
where R₄ represents a hydrogen atom or a halogen atom, R₂, R₃ and R₅ each represent a hydroxyl group, a halogen atom, or CO—R₉ where R₉ represents an alkyl group of from 1 to 20 carbon atoms, and where at least two of R₂, R₃ and R₅ are hydroxyl groups, R₈ represents a hydrogen atom or a 1-4 carbon atom alkyl group, X represents O or S, and Y represents (CH₂)ₖ where k is from 2 to 8, or the grouping —O —(CH₂)ₘ—, m is 0 or a whole number from 1 to 4, n is a whole number from 2 to 8 wherein the sum of m and n is a whole number from 2 to 8.

A preferred specific bifunctional compound (II) is shown in FIG. 3 as compound (VII), having the structure:

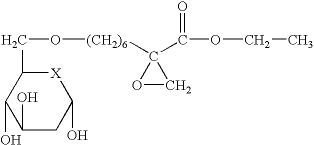

### EXAMPLE 3

One can use in the invention, the bifunctional compound (III) of FIG. 2, having the structure: 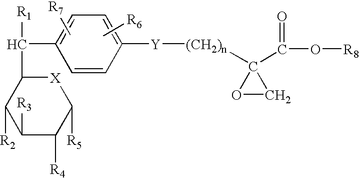
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, and Y represents (CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8.

A preferred specific bifunctional compound (III) is shown in FIG. 3 as compound (VIII), having the structure:

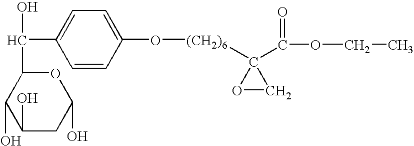

### EXAMPLE 4

One can use in the invention, the bifunctional compound (IV) of FIG. 2, having the structure: 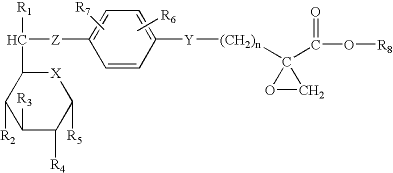
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, Y represents (CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4.

A preferred specific bifunctional compound (IV) is shown in FIG. 3 as compound (IX), having the structure:

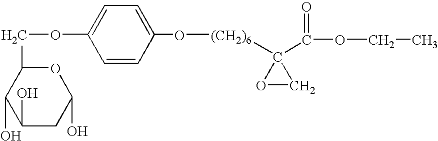

### EXAMPLE 5

One can use in the invention, the bifunctional compound (V) of FIG. 2, having the structure: 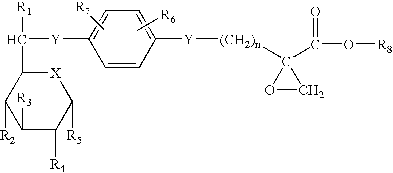
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, and Y represents (CH₂)ₖ where k is from 2 to 8, or the grouping —O—(CH₂)ₘ—, where m is 0 or a whole number from 1 to 4, n is a whole number from 2 to 8 wherein the sum of m and n is a whole number from 2 to 8.

A preferred specific bifunctional compound (V) is shown in FIG. 3 as compound (X), having the structure:

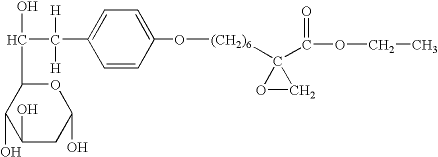

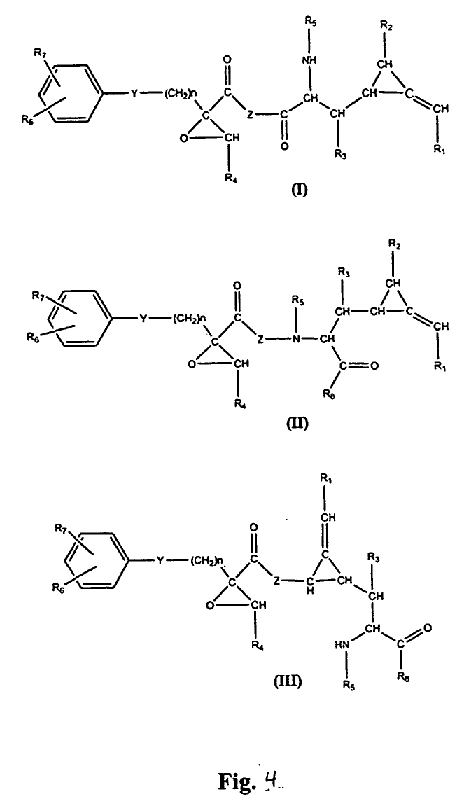

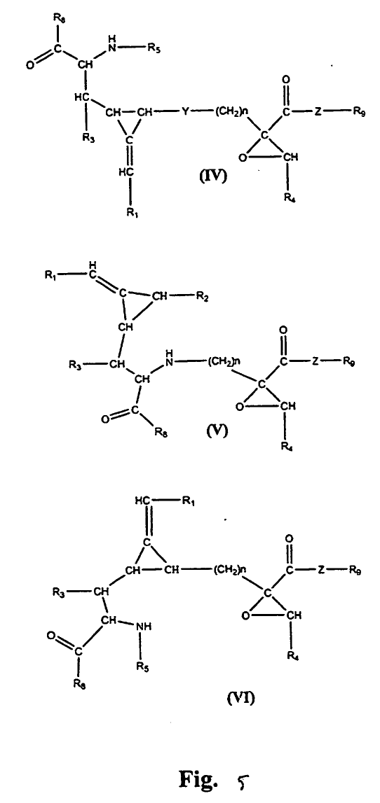

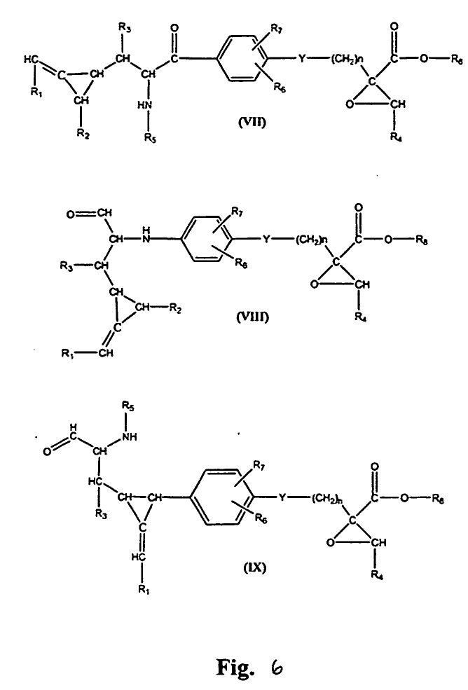

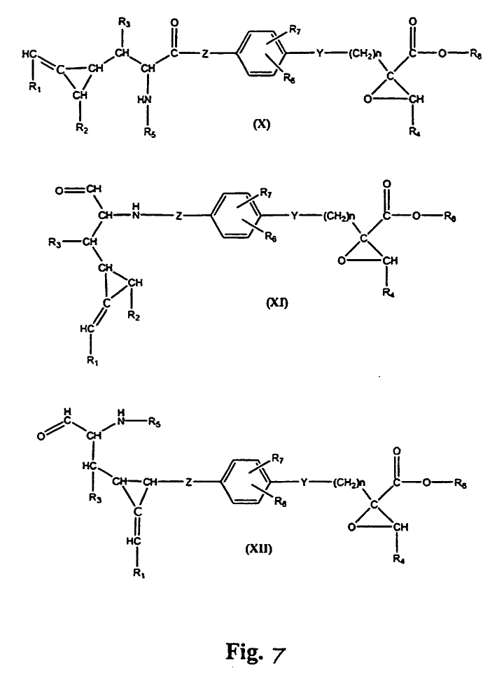

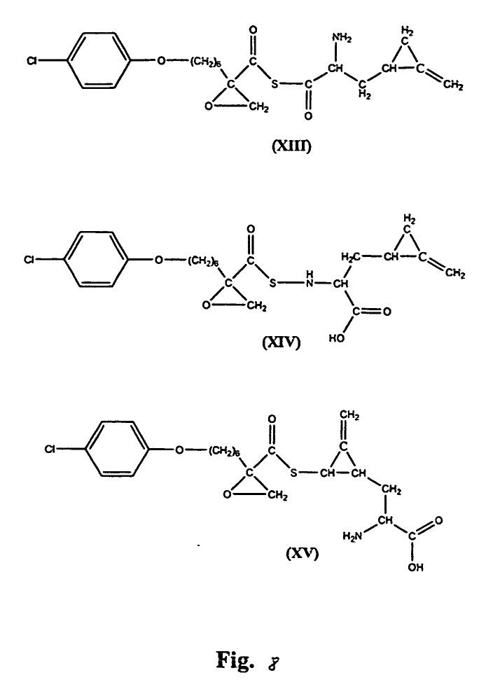

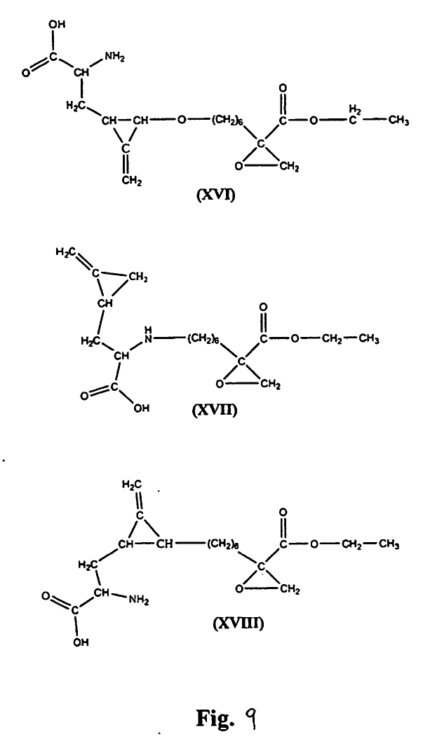

Preferably, the invention provides bifunctional compounds that link a moiety having the functionality of an oxirane carboxylic acid compound to a moiety having the functionality of hypoglycin or a hypoglycin A derivative. Most preferred are bifunctional compounds that link a moiety having the functionality of etomoxir to a moiety having the functionality of hypoglycin A. Referring to FIGS. 4-7, generic forms of twelve bifunctional compounds (I) to (XII), are shown, and respective specific preferred bifunctional compounds (XIII) to (XXVII) are shown in FIGS. 8-12. Each will be referred to in more detail in the following examples, where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7 or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4.

### EXAMPLE 6

One can use in the invention, the bifunctional compound (I) of FIG. 4, having the structure:

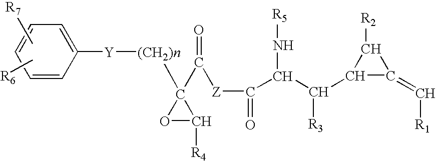

A preferred specific example of bifunctional compound (I) is shown in FIG. 8 as compound (XIII), having the structure:

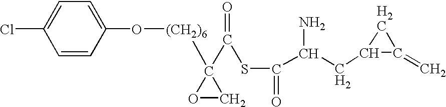

### EXAMPLE 7

One can use in the invention, the bifunctional compound (II) of FIG. 4, having the structure:

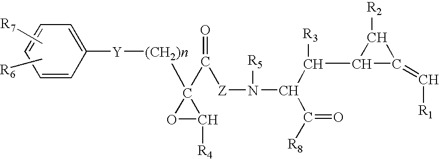

A preferred specific example of bifunctional compound (II) is shown in FIG. 8 as compound (XIV), having the structure:

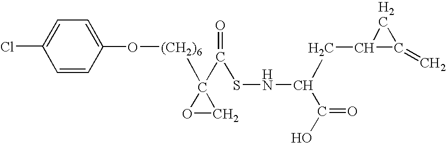

### EXAMPLE 8

One can use in the invention, the bifunctional compound (III) of FIG. 5, having the structure:

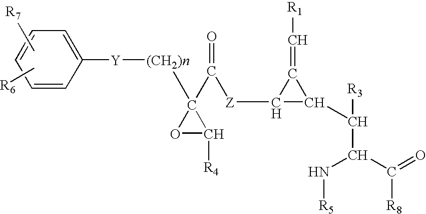

A preferred specific example of bifunctional compound (III) is shown in FIG. 8 as compound (XV), having the structure:

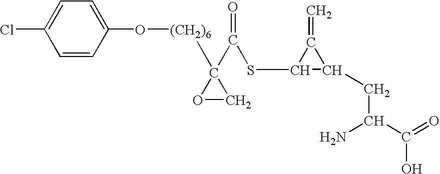

### EXAMPLE 9

One can use in the invention, the bifunctional compound (IV) of FIG. 5, having the structure:

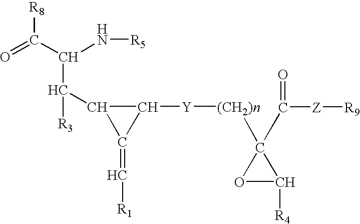

A preferred specific example of bifunctional compound (IV) is shown in FIG. 9 as compound (XVI), having the structure:

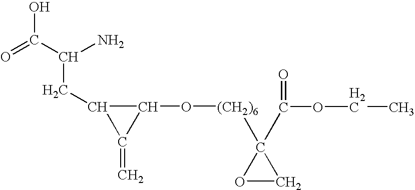

### EXAMPLE 10

One can use in the invention, the bifunctional compound (V) of FIG. 5, having the structure:

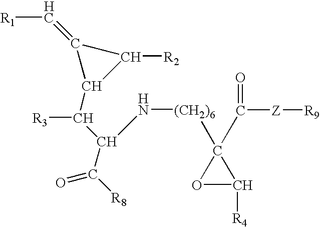

A preferred specific example of bifunctional compound (V) is shown in FIG. 9 as compound (XVII), having the structure:

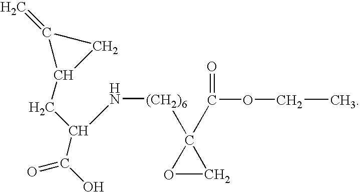

### EXAMPLE 11

One can use in the invention, the bifunctional compound (VI) of FIG. 5, having the structure:

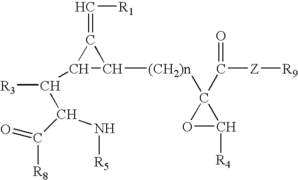

A preferred specific example of bifunctional compound (VI) is shown in FIG. 9 as compound (XVIII), having the structure:

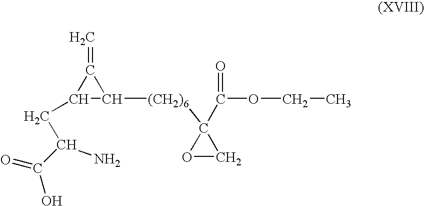

### EXAMPLE 12

One can use in the invention, the bifunctional compound (VII) of FIG. 6, having the structure:

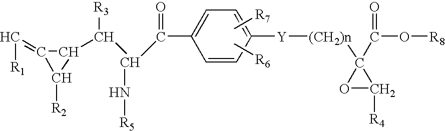

A preferred specific example of bifunctional compound (VII) is shown in FIG. 10 as compound (XIX), having the structure:

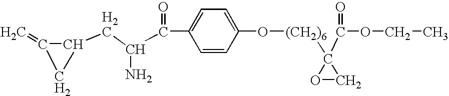

### EXAMPLE 13

One can use in the invention, the bifunctional compound (VIII) of FIG. 6, having the structure:

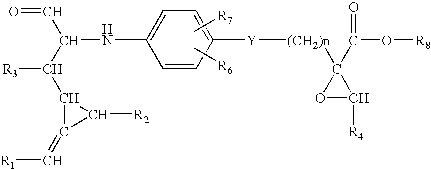

A preferred specific example of bifunctional compound (VIII) is shown in FIG. 10 as compound (XX), having the structure:

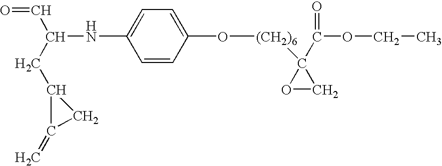

### EXAMPLE 14

One can use in the invention, the bifunctional compound (IX) of FIG. 6, having the structure:

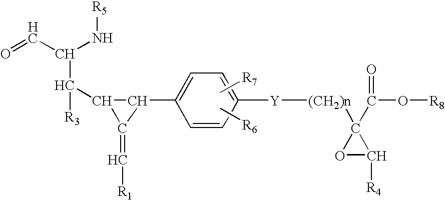

A preferred specific example of bifunctional compound (XXI) is shown in FIG. 9 as compound (XVII), having the structure:

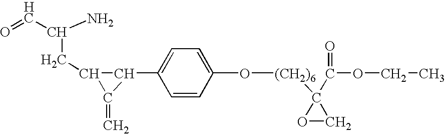

### EXAMPLE 15

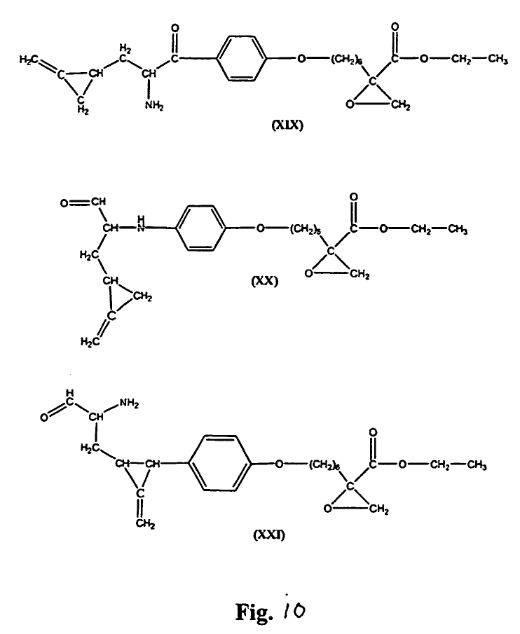

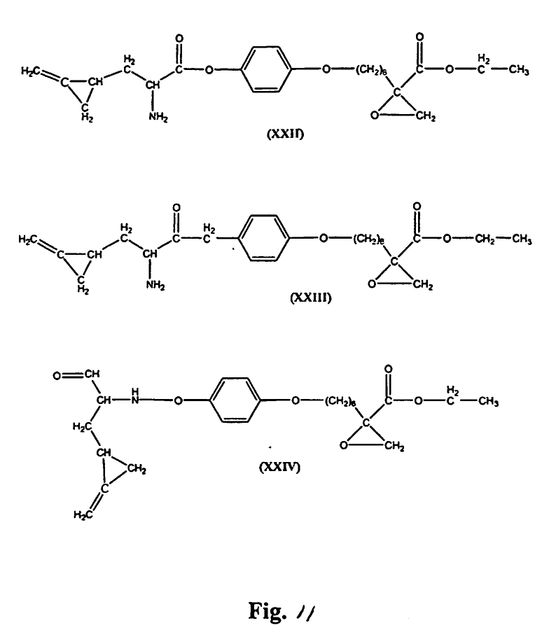

One can use in the invention, the bifunctional compound (X) of FIG. 7, having the structure:

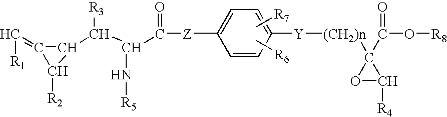

A preferred specific example of bifunctional compound (X) is shown in FIG. 11 as compound (XXII), having the structure:

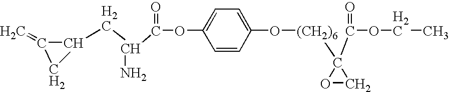

Another preferred specific example of bifunctional compound (X) is shown in FIG. 11 as compound (XXIII), having the structure:

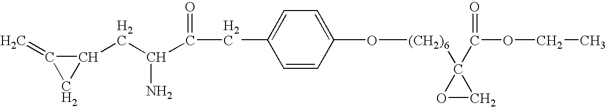

### EXAMPLE 16

One can use in the invention, the bifunctional compound (XI) of FIG. 7, having the structure:

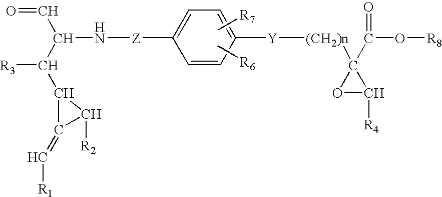

A preferred specific example of bifunctional compound (XI) is shown in FIG. 11 as compound (XXIV), having the structure:

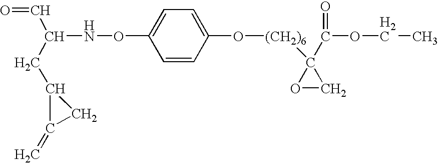

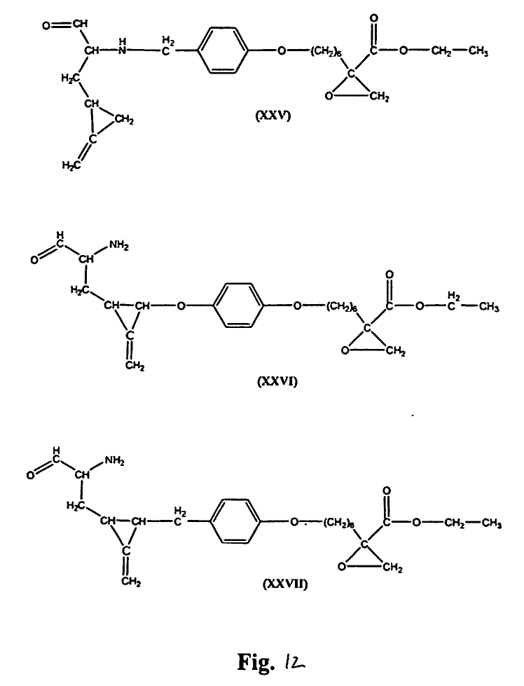

Another preferred specific example of bifunctional compound (XI) is shown in FIG. 12 as compound (XXV), having the structure:

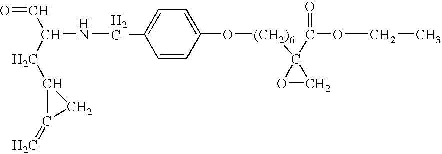

### EXAMPLE 17

One can use in the invention, to treat MDR tumors, the bifunctional compound (XII) of FIG. 7, having the structure:

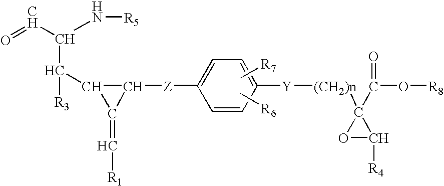

A preferred specific example of bifunctional compound (XII) is shown in FIG. 12 as compound (XXVI), having the structure:

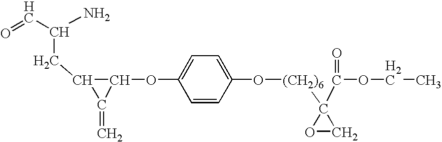

Another preferred specific example of bifunctional compound (XII) is shown in FIG. 12 as compound (XXVII), having the structure:

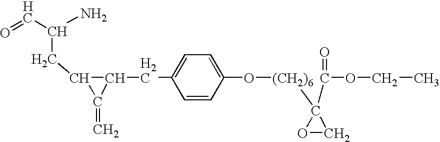

1. A method for modifying the metabolsim of plants or eucaryotic microbes, and for culturing them for the production of lipids with high concentrations of omega-3 highly unsaturated fatty acids, comprising feeding the plant or eukaryotic microbe a metabolic modifier selected from the group consisting essentially of a fatty acid metabolism inhibitor, glycolysis inhibitor, a bifunctional compound that links a fatty acid metabolism inhibitor to a glycolysis inhibitor, glucose, insulin, a plant growth factor, and inhibitors of gluconeogenesis and CO2 fixation in plants that indirectly promote storage of fat.

2. The method of claim 1 in which the metabolic modifier is added to a fermentation or growth medium

3. The method of claim 1 in which the bifunctional compound links a fatty acid inhibitor to an inhibitor that is, or is derived from, or has the functionality of, hypoglycin A.

4. The method of claim 1 in which the fatty acid metabolism inhibitor has the functionality of an oxirane carboxylic acid compound.

5. The method of claim 1 in which the glycolysis inhibitor has the functionality of 2-deoxy-D-glucose.

6. The method of claim 1 in which the bifunctional compound links a moiety having the functionality of etomoxir to a moiety having the functionality of hypoglycin A.

7. The method of claim 1 in which the bifunctional compound links a moiety having the functionality of etomoxir to a moiety having the functionality of 2-deoxy -D-glucose.

8. The method of claim 1 in which the eucaryotic microbes are selected from the group consisting of algae, fungi, protists, and mixtures thereof, wherein the microorganisms are capable of producing polyenoic fatty acids or other lipids which requires molecular oxygen for their synthesis.

9. The method of claim 8 in which the eukaryotic microorganisms are capable of producing lipids at a fermentation medium oxygen level of about less than 3% of saturation.

10. The method of claim 1 in which the fatty acid metabolism inhibitor is selected from the group consisting of:
(a) carboxylic acids having the structure: 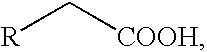
where R comprises an organic moiety and may include at two or more nitrogen atoms, or an aromatic moiety;
(b) compounds having the structure: 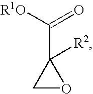
where each of R¹ and R² independently comprises organic moiety in which either or both of R¹ and R² may independently be an alkyl, may include an aromatic moiety, or may have the structure: 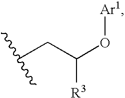
where R³ comprises an organic moiety and Ar¹ comprises an aromatic moiety. R³ may be an alkyl, such as a straight-chain alkyl.;
(c) compounds having the structure: 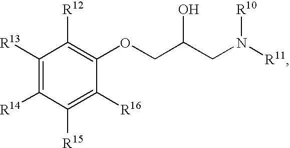
where each of R¹⁰, R¹¹, R¹², R¹³, R¹⁴, R¹⁵ and R¹⁶ independently comprises hydrogen, a halogen, or an organic moiety, or R¹⁰ and R¹¹ together may define an organic moiety; and
(d) compounds having the structure: 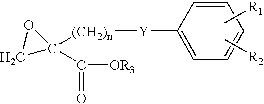
wherein: R₁ represents a hydrogen atom, a halogen atom, a 1-4C alkyl group, a 1-4C alkoxy group, a nitro group or a trifluoromethyl group; R₂ has one of the meanings of R₁; R₃ represents a hydrogen atom or a 1-4C alkyl group; Y represents the grouping —O—(CH₂)ₘ—; m is 0 or a whole number from 1 to 4; and n is a whole number from 2 to 8 wherein the sum of m and n is a whole number from 2 to 8.

11. The method of claim 1 in which the glycolysis inhibitor has the structure: 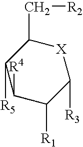
wherein: X represents an O or S atom; R₁ represents a hydrogen atom or a halogen atom; R₂ represents a hydroxyl group, a halogen atom, a thiol group, or CO—R₆; and R₃, R_{4,} and R₅ each represent a hydroxyl group, a halogen atom, or CO— R₆ wherein R₆ represents an alkyl group of from 1 to 20 carbon atoms, and wherein at least two of R₃, R_{4,} and R₅ are hydroxyl groups.

12. The method of claim 1 in which the glycolysis inhibitor is hypoglycin A.
The method of claim 1 in which the bifunctional compound is selected from the group consisting of:
(a) compounds having the structure: 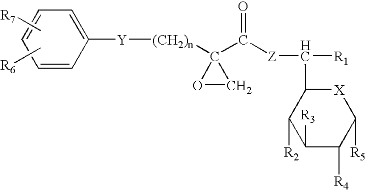
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, Y represents(CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(b) compounds having the structure: 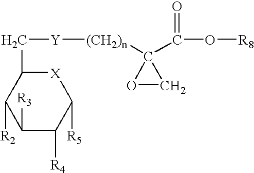
where R₄ represents a hydrogen atom or a halogen atom, R₂, R₃ and R₅ each represent a hydroxyl group, a halogen atom, or CO—R₉ where R₉ represents an alkyl group of from 1 to 20 carbon atoms, and where at least two of R₂, R₃ and R₅ are hydroxyl groups, R₈ represents a hydrogen atom or a 1-4 carbon atom alkyl group, X represents O or S, and Y represents(CH₂)ₖ where k is from 2 to 8, or the grouping —O —(CH₂)ₘ—, m is 0 or a whole number from 1 to 4, n is a whole number from 2 to 8 wherein the sum of m and n is a whole number from 2 to 8;
(c) compounds having the structure: 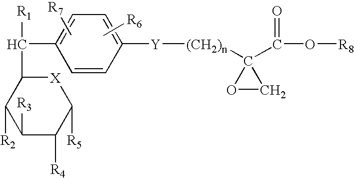
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1- 4 carbon atom alkyl group, X represents O or S, and Y represents(CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8;
(d) compounds having the structure: 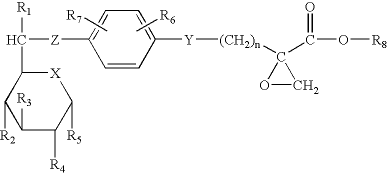
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, Y represents (CH₂)ₖ where k is from 2 to 8, or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(e) compounds having the structure: 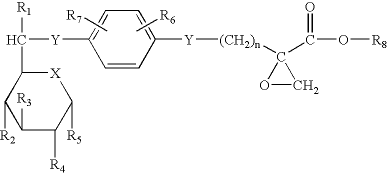
where R₁ represents a hydroxyl group, a halogen atom, a thiol group, or CO—R₉ where R₉ represents an alkyl group of from 1 to 20 carbon atoms, R₄ represents a hydrogen atom or a halogen atom, R₂, R₃ and R₅ each represent a hydroxyl group, a halogen atom, or CO—R₉ and where at least two of R₂, R₃ and R₅ are hydroxyl groups, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, X represents O or S, and Y represents (CH₂)ₖ where k is from 2 to 8, or the grouping —O—(CH₂)ₘ—, where m is 0 or a whole number from 1 to 4, n is a whole number from 2 to 8 wherein the sum of m and n is a whole number from 2 to 8;
(f) compounds having the structure: 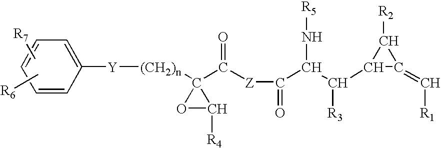
where R₁, R₂, R₃, R4, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(g) compounds having the structure: 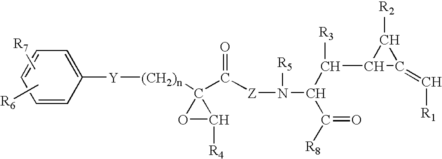
where R₁, R₂, R₃, R_{4,} and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(h) compounds having the structure: 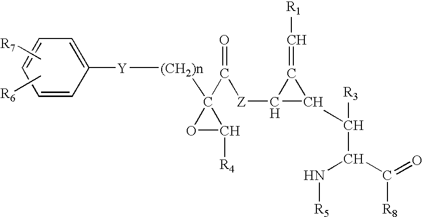
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(i) compounds having the structure: 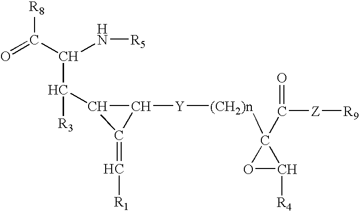
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(j) compounds having the structure: 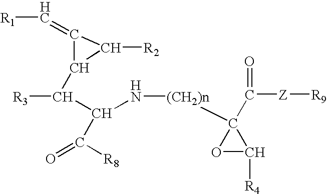
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(k) compounds having the structure: 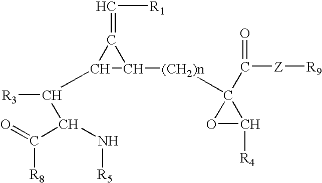
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(I) compounds having the structure: 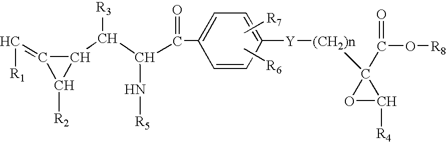
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(m) compounds having the structure: 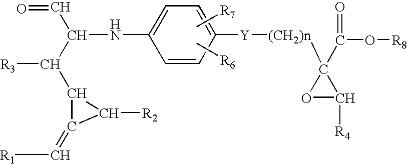
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(n) compounds having the structure: 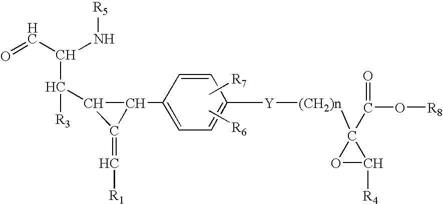
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(o) compounds having the structure: 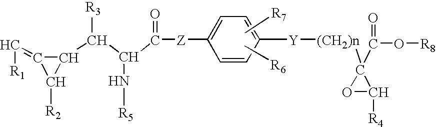
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4;
(p) compounds having the structure: 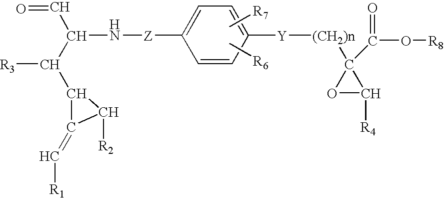
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1-4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4; and
(q) compounds having the structure: 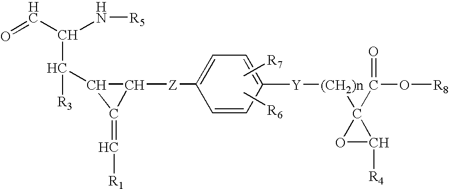
where R₁, R₂, R₃, R₄, and R₅ represents a hydroxyl group, a halogen atom, a thiol group, or CO—R₉ where R₉ represents an alkyl group of from 1 to 20 carbon atoms, R₆ and R₇ each represent a hydrogen atom, a halogen atom, a 1-4 carbon atom alkyl group, a 1-4 carbon atom alkoxy group, a nitro group or a trifluoromethyl group, R₈ represents a hydrogen atom or a 1- 4 carbon atom alkyl group, Y represents (CH₂)ₖ where k is from 2 to 8, 7or the grouping —O—(CH₂)ₘ—, m is 0 or a whole number from 1 to 4, n is a whole number from 2 to 8 wherein the sum of m and n is a whole number from 2 to 8, and Z represents O, S or the grouping (CH₂)ₚ—O—(CH₂)_{q} or (CH₂)ₚ—S—(CH₂)_{q}, and p and q are each 0 or a whole number from 1 to 4.
